(19) United States
(12) Patent Application Publication
(10) Pub. No.: US 2007/0149397 A1
(43) Pub. Date: Jun. 28, 2007

(54) Photocatalytic composite material, method for producing the same and application thereof

(75) Inventors: Yao-Hsuan Tseng, Taoyuan (TW); Yao-Ling Huang, Hsinchu (TW); Shu-Ling Liu, Miaoli (TW); Yu-Ming Lin, Hsinchu (TW); Chia-Hung Huang, Taipei (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 11/489,555

(22) Filed: Jul. 20, 2006

(30) Foreign Application Priority Data
Dec. 22, 2005 (TW) 94145749

(51) Int. Cl. B01J 23/00; B01J 29/04; B01J 21/18; C01B 31/08

(52) U.S. Cl. 502/350; 502/416; 502/417; 502/60; 502/180; 502/182; 502/183

(57) ABSTRACT

The present invention relates to a photocatalytic composite material, a method for producing the same and application thereof. This invention can maintain the activity of a photocatalytic adsorbent and reduce energy consumption by immersing an adsorbent material into a nano-photocatalyst sol to immobilize the nano-sized photocatalyst on the surface of the adsorbent material without a high-temperature calcinations step or using an adhesive agent. Besides, immobilizing the photocatalytic composite material onto a filter can be applied to the equipment for cleaning environment.

### BACKGROUND OF THE INVENTION

1. Field of the Invention

The present invention relates to a method for producing photocatalytic composite material and more particularly relates to a photocatalytic composite material and application thereof.

2. Description of the Related Art

Nanotechnology is the technology for producing material in the size of 10⁻⁹ meter (1 nanometer is equal to 10⁻⁹ meter), measuring its properties, and applying the nano-sized material in the making of devices. Nanomaterials come in a wide variety and cover the fields of semiconductor, metal, polymer, biomedicine, carbon tube, etc. Nanomaterials are typically applied with their electrical, optical, magnetic, and chemical properties. The novel characteristics of nanomaterials are also applicable to industrial catalyst to enhance the surface area of the catalyst. The doping of nanomaterial can also be used to enhance the mechanical strength of devices. Turning semiconductor materials into nano-size can create high quantum confinement of electron and hole to increase the illumination efficiency and decrease the excitation temperature of semiconductor laser. The availability of nanosized semiconductor can further reduce the size of optical and electrical components. Nanotechnology will make the integration of electronic, optical, magnetic and bio components possible.

Nano-sized photocatalyst have been used extensively to improve our living environment and gradually accepted by the consumer public. Nano-sized photocatalyst generally means particle size under 30 nm. Under visible-light or ultraviolet irradiation, active species is produced on the surface of nanoparticle which can oxidize or reduce the pollutants. In addition, the photocatalyst coating is highly photo-induced hydrophilic, it can be applied to anti-fog, anti-dust and other self-cleaning functions. Nano-sized photocatalyst has been used extensively for pollutant removal, air cleaning, water purification, odor removal, sterilization, anti-dust and anti-fog purposes.

Despite of their activities of sterilization and pollutant removal, nano-szied photocatalysts in the form of particles cannot be used directly. The nanoparticles instead must be immobilized on the surface of certain substrate, e.g. ceramic, glass, wall, metal or some plastic materials, which does not be oxidized by nano-sized photocatalyst. That is, the surfaces of those substrates themselves will not be oxidized or decomposed by the nano-sized photocatalyst. The adhesion between the photocatalyst particles and substrate after immobilization is the primary factor determining the service life of photocatalyst. For convenience sake, the immobilization process is carried out with the photocatalyst prepared into aqueous solution, such as sol and slurry. Currently the production of photocatalyst sol is produced form metal salt as precursor. In the example of common titania photocatalyst, the titanium alkanoxide salt and titanium inorganic salt are used as precursor to synthesize titania photocatalyst sol with particle size under 100 nm. Other approaches to preparing photocatalyst sol include mixing photocatalytic powder directly with water. However such approach needs to address further the problem of dispersion to render the nanoparticles more durable and functional in subsequent adhesion process. That is, if the photocatalyst adheres strongly to the substrate, it will continue to function and becomes a product with long-standing effects of dirt removal, odor removal, anti-bacteria, anti-fog and self-cleansing.

Currently the methods for immobilizing nano-sized photocatalyst on the substrate surface include heating photocatalyst precursor at high-temperature or using silicon dioxide or resin as adhesive agent. The former method involves high temperature and consumes energy; the latter results in reduced activity of nano-sized photocatalyst due to the presence of adhesive agent. In addition, the immobilization of the photocatalyst, if any, is further reduced under the influence of calcination or adhesive agent. Thus the development of technology that can maintain the activity of photocatalyst after immobilization, while maintaining the property of substrate has become an important direction in the field of photocatalyst application.

### SUMMARY OF THE INVENTION

To address the drawbacks of prior arts, the object of the present invention is to provide a photocatalytic composite material and a method for immobilizing photocatalyst with adsorbent materials without high energy consumption or use of adhesive agent, thereby maintaining the activity and adsorbent property of photocatalyst.

Another object of the present invention is to provide a material with photocatalytic activity and adsorbency that allows photocatalytic composite material to combine with different materials for application in air cleaning or water purifying equipment or devices.

To achieve the aforesaid objects, the method for preparing photocatalytic composite material according to the invention comprises the steps of: a) providing a photocatalyst sol; b) immersing an adsorbent material into the photocatalyst sol and mixing; and c) drying the photocatalyst sol to obtain the photocatalytic composite material.

The method for preparing photocatalytic composite material according to the invention can be further added with a solvent washing and drying step subsequent to step c).

A photocatalytic composite material without adhesive agent is prepared using the method according to the invention. Said composite material comprises: an adsorbent material; and a photocatalyst deposited on the surface of adsorbent material.

Furthermore, the photocatalytic composite material according to the invention can be used to produce a material with photocatalytic activity and adsorbency, which comprises: at least a layer of thermoplastic material; and photocatalytic composite material immobilized on the layer of thermoplastic material.

In a preferred embodiment, the thermoplastic material is a non-woven fabric. Preferably the non-woven fabric comes in two layers or more and the photocatalytic composite material is dispersed between the non-woven fabric layers.

The thermoplastic material with photocatalytic activity and adsorbency has the photocatalytic composite material immobilized thereon via rolling, pressing and thermal treatment.

The photocatalytic composite material with nano-sized photocatalyst deposited on adsorbent material according to the invention is prepared without the use of high temperature or adhesive agent, while the activity of nano-sized photocatalyst and the adsorbency of adsorbent material are retained. The photocatalytic composite material can be further combined with other materials, such as non-woven fabric, to be made into flexible products. In actual applications, the adsorption of pollutants by the absorbent material and the decomposition of pollutant by the photocatalyst improve the cleansing of air quality or water quality.

### BRIEF DESCRIPTION OF THE DRAWINGS

FIG. 1 shows the performance of non-woven fabric with photocatalytic activity and adsorbency according to the invention in nitrogen oxide removal.

FIG. 2 shows the performance of non-woven fabric with photocatalytic activity and adsorbency according to the invention in acetaldehyde removal.

FIG. 3 shows the performance of commercial non-woven fabric with activated carbon in acetaldehyde removal.

### DETAILED DESCRIPTION OF THE INVENTION

The method for preparing photocatalytic composite material according to the invention comprises the steps of first providing a photocatalyst sol contained with the ultraviolet-light and/or visible-light activated nano-material, such as titanium dioxide, zinc oxide or tin dioxide. The photocatalyst sol may be a metal oxide sol made of metallic inorganic salt and metallic organic compounds or may be obtained by mixing nano-powder with water or any available photocatalyst sol on the market. Generally, photocatalyst has particle sizes of 2˜400 nm, and its solid content in the photocatalyst sol ranges between 0.01 wt %˜50 wt %.

Next, immerse an adsorbent material into the aforesaid photocatalyst sol and agitate. The adsorbent material refers to a material with porous surface that can adsorb minute substances, such as activated carbon, zeolite, carbon fiber or nano carbon tube. Due to their porous structure, these materials typically have larger surface area and some are electrically charged and able to adsorb pollutants.

The action of “immersing” in the invention is put the adsorbent material into the photocatalyst sol and letting the adsorbent material be coated with photocatalyst sol; “agitating” means homogenizing the adsorbent material in the photocatalyst sol by means of manual/mechanical agitation or ultrasonic vibration. The duration of agitation or vibration depends on the dispersion state of adsorbent material in the photocatalyst sol. The weight percentage ratio of photocatalyst in the photocatalyst sol to adsorbent material may be adjusted according to the surface volume of the adsorbent material, which in general ranges between 0.1 wt % and 15 wt %.

The photocatalyst sol containing adsorbent material after immersion and agitation is draw out for drying. At this time, the photocatalyst forms nanoparticles which are immobilized onto the surface of adsorbent material and photocatalytic composite material is obtained after drying. The drying time and temperature in the process depends on the volatility and boiling point of solution. In the example of water, the drying temperature can be 20˜150° C. and drying time ranges from 1 hour to 240 hours.

In some embodiments, the photocatalyst sol contains less volatile organic solvent or acid so that the photocatalytic composite material is further washed with volatile solvent fter drying to remove those organic solvent or acid. An example of the volatile solvent is water. After washing, the photocatalytic composite material is again dried. This solvent washing and drying step may be repeated as many times as necessary in view of the properties of the photocatalytic composite material and the photocatalyst sol.

The photocatalytic composite material prepared according to the method just described comprises: an adsorbent material; and a nano-sized photocatalyst deposed on the surface of adsorbent material. The definitions and proportions of adsorbent material and photocatalyst are as described above.

Furthermore, the photocatalytic composite material according to the invention can be used as a raw material for producing a material with photocatalytic activity and adsorbency, which comprises: at least a layer of thermoplastic material; and a photocatalytic composite material of the invention immobilized thereon.

The so-called “layer of thermoplastic material” refers to a laminated carrier with pores made of thermoplastic polymer, such as non-woven fabric containing polyester and polyolefin. In a preferred embodiment, the non-woven fabric material contains at least two layers with the photocatalytic composite material dispersed in the interval.

The methods for producing non-woven fabric material having photocatalytic activity and adsorbency are known in the field of the invention, where the photocatalytic composite material is immobilized to the non-woven fabric by means of rolling, pressing and heating.

The advantages of the present invention are further depicted in the illustration of examples, but the descriptions made in the examples should not be construed as a limitation on the actual application of the present invention.

### EXAMPLE 1

### Preparation of Photocatalytic Composite Material and Non-Woven Fabric with Photocatalytic Activity/Absorbency made of the Composite Material

Preparation of Photocatalytic Composite Material

Take 1 L of TiO₂ sol containing 3 wt % TiO₂ and particle size averaging 3-7 nm. Add 200 g activated carbon powder into the solution. The activated carbon powder preferably has large surface area and can pass through 20×60 mesh (more preferably activated carbon powder with BET surface area of more than 500 m²/g). Mix and agitate the solution for one hour and then dry for 4-5 hours. Subsequently perform the step of washing with water and drying if necessary. The resulting solid is photocatalytic composite material made of TiO₂/activated carbon powder, where the weight percentage of TiO₂ and activated carbon powder is approximately 8%.

Preparation of Non-Woven Fabric with Photocatalytic Activity and Absorbency

Spread photocatalytic composite material evenly over the surface of non-woven fabric by the proportion of approximately 200 g of photocatalytic composite material per m² of non-woven fabric. Immobilize the photocatalytic composite material onto the non-woven fabric by rolling, pressing and heating to produce non-woven fabric with photocatalytic activity and absorbency. In the rolling, pressing and heating process, photocatalyst/activated carbon powder is laid uniformly between two layers of non-woven fabric (the fabric is made of PP/coPET with an unit weight of 50-100 g/m²), and a metal cylinder is used as a roller, which is heated to 70˜120° C. and presses the two layers of non-woven fabric to immobilize the photocatalyst/activated carbon powder in the interval. The activated carbon powder retains good light permeability after immobilization on the non-woven fabric and can be used in air filter, water filter or anti-bacterial material.

### EXAMPLE 2

### The Performance of Composite Material with Photocatalytic Activity and Adsorbency According to the Invention in NOx Removal

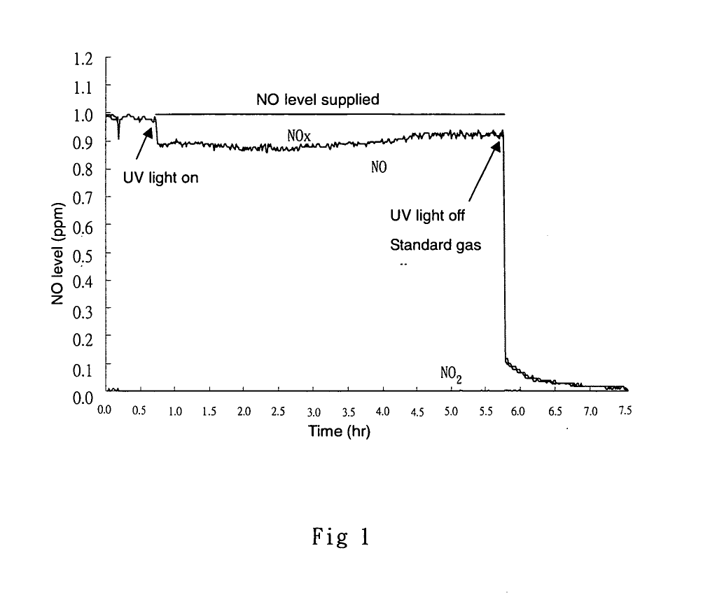

The testing of the photocatalytic composite material according to the invention in NOₓ removal was proceeded according to JIS R1701-1, where standard gas of NO and dry and moist air were fed into a flow meter to control the RH (74.4%), concentration (1 ppm), flow rate (3 L/min) and temperature (24° C.) of tested gas (NO), which was subjected to 5 hours of photocatalytic reaction. The light source was the lamp for an insect trap with main wavelength at 365 nm. Based on the test result as in FIG. 1, it is shown that the photocatalytic composite material of the invention exhibits photocatalytic activity to degrdate NOₓ gas. In 5 hours of continuous reaction, it has removed 8.5 μmol of nitrogen oxides. In addition, NO₂, the intermediate product usually present in NO photocatalytic reaction was very few in this embodiment, indicating the excellent photocatalytic effect of the composite material, which maintained its photocatalytic activity for a long period.

### EXAMPLE 3

### The Performance of Composite Material with Photocatalytic Activity and Adsorbency According to the Invention in Acetaldehyde Removal

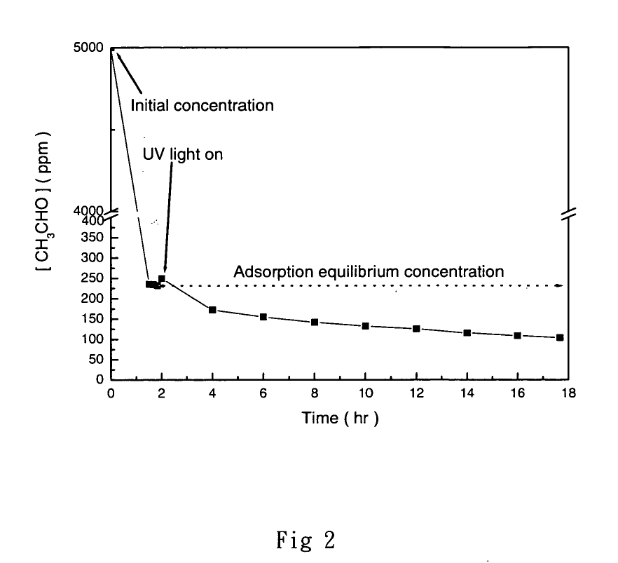

The testing of the photocatalytic composite material according to the invention in acetaldehyde removal was proceeded according to photocatalyst performance evaluation test method IIb proposed by SITPA, where standard gas of CH₃CHO and dry and moist air were fed into a batch reactor in the controlled conditions, i.e., RH (24.4%), concentration (5000 ppm), and temperature (18° C.), which was subjected to 16 hours of photocatalytic reaction. The photocatalytic composite material of the invention was placed in sealed sampling bag and allowed to undergo adsorption in the dark for 3 hours. After the adsorption reached equilibrium, the light source was turned on for the photo-decomposition experiment. As shown in FIG. 2, the feeding concentration of acetaldehyde was 5000 ppm, which reached an equilibrium of around 250 ppm after 3 hours of adsorption. After the light source was turned on, the concentration of acetaldehyde decreased gradually to 100 ppm after 16 hours of decomposition under the photocatalytic activity. It is thus known that the photocatalytic composite material of the invention works in two folds—break down the acetaldehyde in gaseous phase and break down the acetaldehyde adsorbed on the filter. Under light irradiation, acetaldehyde was decomposed, while the adsorbency of the adsorbent material was regenerated. The test results indicate that the photocatalytic composite material of the invention exhibits both high adsorbency and high photocatalytic activity.

### COMPARATIVE EXAMPLE 1

### The Performance of Non-Woven Fabric with Regular Activated Carbon Adsorbency in Acetaldehyde Removal

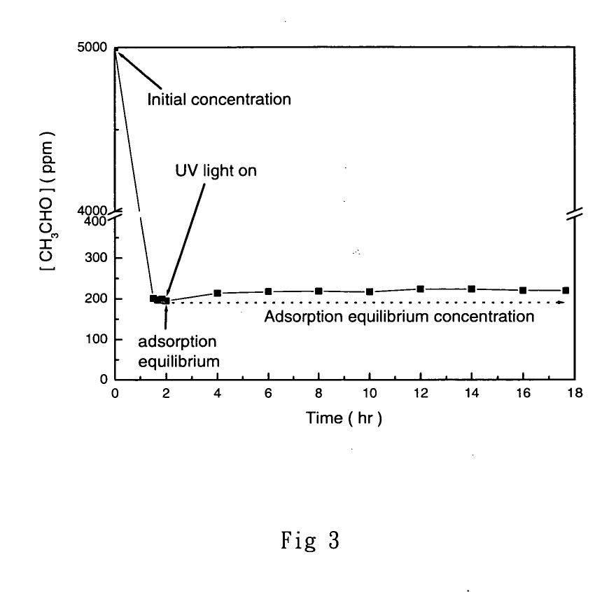

Non-woven fabric carrying 200 g/m² of activated carbon was tested for comparison purpose. The testing was conducted according to photocatalyst performance evaluation test method IIb proposed by SITPA, where standard gas of CH₃CHO and dry and moist air were fed into a batch reactor in the controlled conditions, i.e., RH (24.4%), concentration (5000 ppm), and temperature (18° C.), which was subjected to 16 hours of reaction. As shown in FIG. 3, the feeding concentration of acetaldehyde was 5000 ppm, which reached an equilibrium of around 200 ppm after 2 hours of adsorption. After the light source was turned on, the concentration of acetaldehyde went up to 220 ppm under the effect of thermal desorption. As compared to the result of Example 3 as shown in FIG. 3, the acetaldehyde kept at the similar concentration without decreasing after 16 hours of UV irradiation, indicating the difference between the activity of the regular activated carbon filter and the photocatalytic composite material of this invention.

To sum up, the present invention provides a method for preparing photocatalytic composite material under low temperature without the use of adhesive agent. The resulting composite material possesses excellent photocatalytic activity and adsorbency for micro substances. Furthermore, the photocatalytic composite material can be combined with non-woven fabric to produce non-woven fabric with photocatalytic activity and adsorbency. Such non-woven fabric may be used in air filter and water filter where pollutants are adsorbed by the filter and then decomposed by its photocatalytic activity to achieve the effect of air or water cleaning.

### Other Embodiments

All features of the invention disclosed herein can be combined with other methods and each feature may be selectively replaced by a feature with identical, equivalent or similar object. Thus except for particularly prominent features, all features disclosed in the description are only an example of equivalent or similar feature.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A method for preparing photocatalytic composite material, comprising the steps of
a) providing a photocatalyst sol;
b) immersing and mixing an adsorbent material into said photocatalyst sol; and
c) drying the photocatalyst sol with adsorbent material to obtain a photocatalytic composite material.

2. The method according to claim 1, wherein the photocatalyst sol in step a) is titanium dioxide, zinc oxide, tin dioxide, or mixtures thereof.

3. The method according to claim 1, wherein the photocatalyst solid content in said photocatalyst sol in step a) is 0.01 wt %˜50 wt %.

4. The method according to claim 1, wherein the adsorbent material in step b) is zeolite, activated carbon, carbon fiber or nano carbon tube.

5. The method according to claim 1, wherein the weight percentage ratio of photocatalyst in photocatalyst sol to adsorbent material in step b) is 0.01 wt %˜15 wt %.

6. The method according to claim 1, further comprising a step of solvent washing and drying after step c).

7. The method according to claim 6, wherein the solvent is water.

8. A photocatalytic composite material, comprises:
an adsorbent material; and
a nano-sized photocatalyst disposed on the surface of said adsorbent material.

9. The photocatalytic composite material according to claim 8, wherein the nano-sized photocatalyst is titanium dioxide, zinc oxide, tin dioxide, or mixtures thereof.

10. The photocatalytic composite material according to claim 8, wherein the adsorbent material is zeolite, activated carbon, carbon fiber or nano carbon tube.

11. The photocatalytic composite material according to claim 8, wherein the weight percentage ratio of photocatalyst to adsorbent material is 0.01 wt %˜15 wt %.

12. A material with photocatalytic activity and adsorbency, comprises:
at least a layer of thermoplastic material; and
a photocatalytic composite material of claim 8 immobilized on said thermoplastic material.

13. The material according to claim 12, wherein the layer of thermoplastic material is a layer of non-woven fabric.

14. The material according to claim 13, wherein the non-woven fabric has at least two layers.

15. The material according to claim 13, wherein the photocatalytic composite material is disposed between the non-woven fabric layers.

16. The material according to claim 15, wherein the photocatalytic composite material is immobilized onto the non-woven fabric layers by rolling, pressing and heating.

17. The material according to claim 13, wherein the non-woven fabric is made of polyester, polyolefin, or mixtures thereof.
